(19) United States
(12) Patent Application Publication
(10) Pub. No.: US 2006/0131905 A1
(43) Pub. Date: Jun. 22, 2006

(54) Negative-pressure valve device to be used in general purpose gripping panel devices

(76) Inventor: Giacobbe Mazzucchelli, Misinto (Milano) (IT)

Correspondence Address: HEDMAN & COSTIGAN P.C., 1185 AVENUE OF THE AMERICAS, NEW YORK, NY, 10036, US

(21) Appl. No.: 11/304,095

(22) Filed: Dec. 15, 2005

(30) Foreign Application Priority Data
Dec. 20, 2004 (IT) MI2004A 002428

(51) Int. Cl. B25J 15/06

(52) U.S. Cl. 294/64.1

(57) ABSTRACT

A negative-pressure valve device to be used in general purpose gripping panel devices comprises a flat spring or “clapet” arranged in a two-step cavity and having a shape depending on a size of a seat receiving the flat spring, which flat spring comprises, on a face thereof, an opening and being adapted to bear on said seat so as to close the passage thereof, as an air flow, generated by a diffusion vacuum pump, and flowing through the cavity, as acquired a force sufficient to deform it.

### BACKGROUND OF THE INVENTION

The present invention relates to a negative-pressure valve device, specifically for application to general purpose gripping panels.

It is known, for handling different articles, to use gripping flat panels, comprising a plurality of suction cup suction points.

To allow the raising system to properly operate, it is required that all the suction cups thereof are engaged by the article or articles to be raised, i.e. that the unengaged suction cups are closed to prevent losses susceptible to reduce the negative pressure in the engaged suction cups.

For achieving the above, very complex valving mechanisms are used, for closing or insulating the unengaged suction cups; however, it should be self evident that the designing and making of these systems are very complex and expensive.

Moreover, such a gripping mechanism is not suitable for raising simultaneously a plurality of different articles or objects.

### SUMMARY OF THE INVENTION

Accordingly, the aim of the present invention is to provide such a valving device, for application to general purpose gripping panels, which is very simple construction-wise and inexpensive.

Within the scope of the above mentioned aim, a main object of the invention is to provide such a negative-pressure valve device which is adapted to reduce the power to be used for holding in said device a sufficient negative pressure level.

Yet another object of the present invention is to provide such a valve device which is very reliable in operation and has very high safety characteristics.

According to one aspect of the present invention, the above mentioned aim and objects, as well as yet other objects, which will become more apparent hereinafter, are achieved by a negative-pressure valve device, for application to general purpose gripping panels, characterized in that said device comprises a flat spring arranged in a two-step cavity and having a shape depending on a size of a seat receiving said flat spring, said flat spring comprising, on a face thereof, an opening and being adapted to bear on said seat to close a passage thereof, as an air flow, generated by a diffusion vacuum pump and passing through said cavity, as acquired a strength sufficient to deform said flat spring.

### BRIEF DESCRIPTION OF THE DRAWINGS

Further characteristics and advantages of the present invention will become more apparent hereinafter from the following disclosure of a preferred, though not exclusive, embodiment of the invention, which is illustrated, by way of an indicative, but not limitative, example, in the accompanying drawings, where:

FIG. 1 is a schematic elevation view, in cross section, of a valve device according to the present invention;

FIG. 2 is a top plan view of the valve device according to the invention;

FIG. 3 is a further elevation view, as partially cross-sectioned, of the inventive device applied to a suction cup construction;

FIG. 4 is a detail view, as partially cross-sectioned, of the valve device according to the invention;

FIG. 5 is a further side view, in cross section, of a general purpose gripping panel, including valve devices according to the invention, and shown in an operating step thereof in which said gripping panel is moved toward an article or object to be raised;

FIG. 6 is a further side elevation view, similar to the preceding view, but illustrating the gripping panel during an operating step thereof for gripping the article or object;

FIG. 7 is a view similar to FIG. 6, but illustrating the gripping panel releasing the gripped article or object;

FIG. 8 schematically illustrates that the gripping plane, including the valve devices according to the present invention, can assume any desired space position;

FIG. 9 is a side cross-sectional view, on an enlarged scale, of a negative-pressure chamber 10, including a bottom panel 21, having a Velcro® or other similar material, adapted to be affixed on the bottom surface of a suction cup supporting plate, to which the resilient flat springs or “clapets” are applied; and

FIG. 10 is a further side cross-sectioned view, showing the above mentioned negative-pressure chamber which comprises a bottom panel 21, to which are applied said resilient clapets, and comprising a foamed rubber or like material elements also fixed by a Velcro® material to the bottom plate of the negative-pressure chamber.

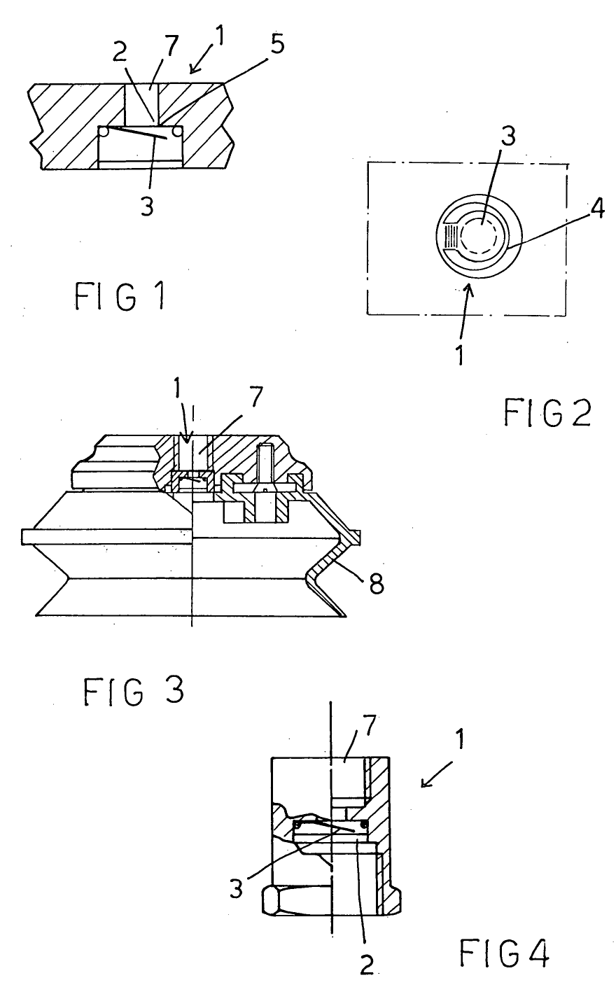

### DESCRIPTION OF THE PREFERRED EMBODIMENTS

With reference to the number references of the above mentioned figures, the valve device according to the invention, which has been generally indicated by the reference number 1, comprises, in a two-step cavity 2, a flat spring 3, having a size which depends on the size of the seat or recess 4 therefor.

The flat spring 3, which can also be conventionally called “clapet/resilient element” comprises, on a face thereof, an opening which can have a circular configuration or any other desired configurations.

As the clapet/resilient element 3 is deformed, it will bear on a coupling seat 5 therefor, to close the passage through the latter.

The closure of the clapet/resilient element 3 is obtained as the air flow, generated by a diffusion vacuum pump, passing through said cavity 2, has acquired a strength sufficient to deform said clapet/resilient element 3.

The power provided by the air flow is generated by the air kinetic energy, which, by impinging on a flat surface, generates a pressure which is transformed into a force.

Upon closing the clapet/resilient element, which is not a tight closure, in the chamber 7, between the diffusion vacuum pump and clapet/resilient element 3 a negative pressure holding said clapet/resilient element 3 in its closure position is generated.

The opening arranged through the clapet/resilient element 3 will hold a small air flow, to balance said clapet/resilient element 3 as the negative pressure holding it in its closure condition stops.

In this connection, it should be apparent that the above mentioned clapet/resilient element 3 is advantageously applied to a suction cup 8, either on a fitting or on a gripping surface or panel 9, having a plurality of passages 7, but with a single negative-pressure chamber 10.

In said negative-pressure chamber 10, a diffusion vacuum pump generates an air flow through the mentioned clapet/resilient elements 3, thereby causing the latter to close.

The closure of said clapet/resilient elements 3 provides, in turn, a high negative-pressure or vacuum condition, which can be properly used.

Actually, as an article or object 11 is arranged under the suction cup 8 or the latching chamber 9, the air flow passing through the clapet/resilient element 3 will be shut off.

Then, pressures will be balanced and the clapet/resilient element 3 opened, while providing a maximum negative pressure or vacuum on the article or object.

This opening causes the air flow rate to achieve a maximum value.

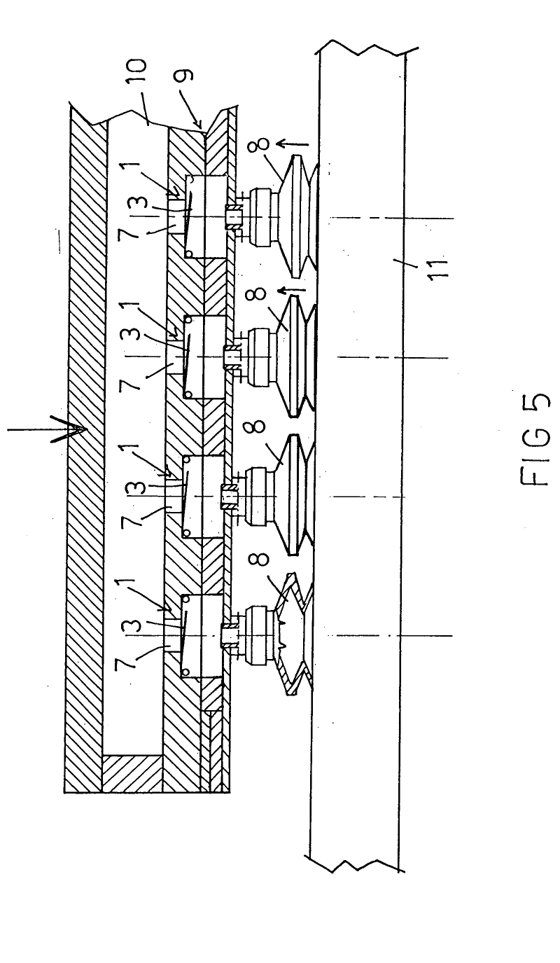

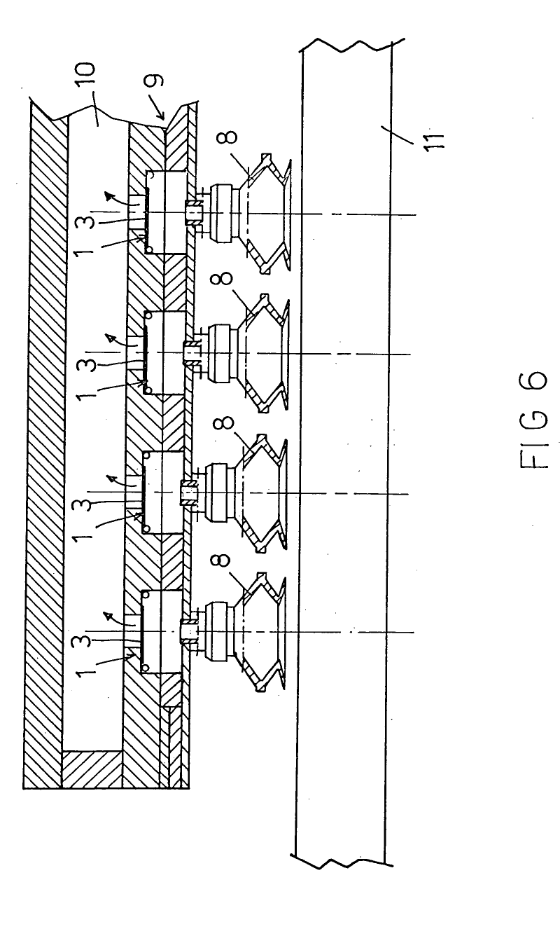

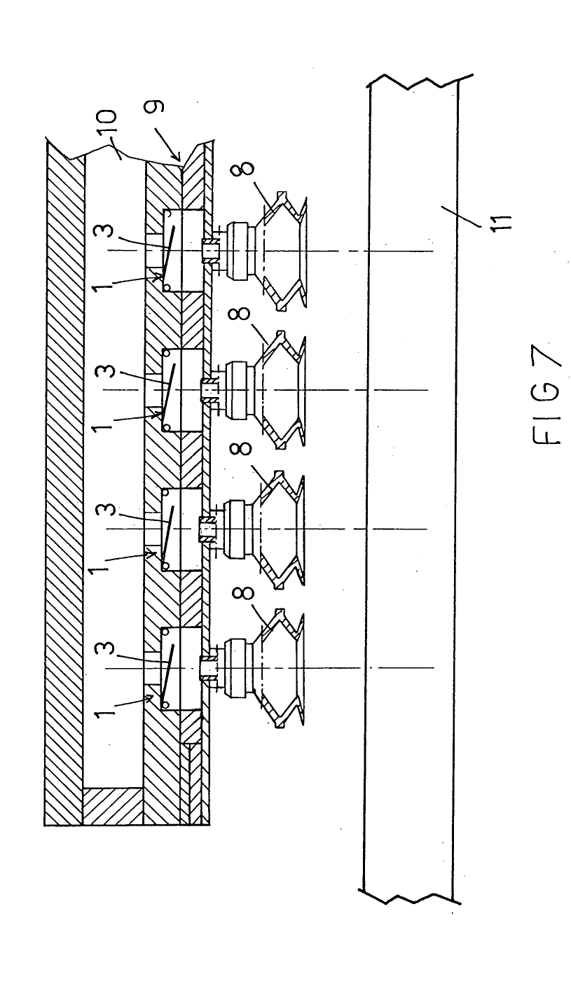

Consequently, by applying this valve means on a panel, as it is schematic shown in FIGS. 5-7, a great energy amount will be saved, since only the clapet/resilient elements 3 covered by the articles 11 will be opened.

The other clapet/resilient elements 3, will be held in a closed condition, thereby preventing the negative pressure or vacuum level from decreasing.

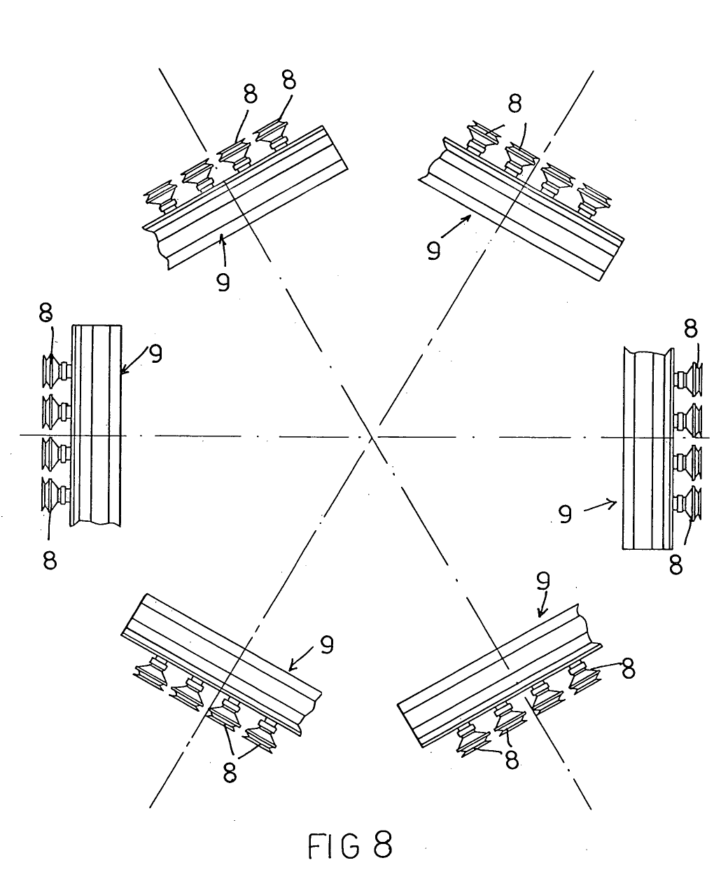

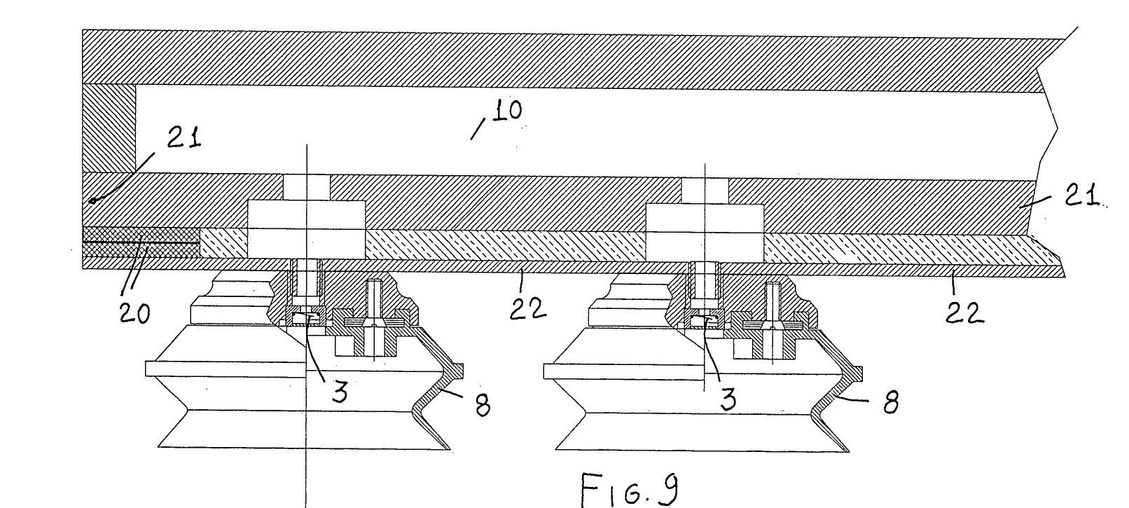

This gripping is achieved in all directions, i.e. both upward and downward and horizontally, as it is schematically shown, by way of an example, in FIG. 8.

With reference to FIG. 9, is herein shown the negative pressure or vacuum chamber including a bottom surface, having a Velcro® strip or other like gripping element 20.

Said gripping element is designed for fixing on a bottom surface or panel 21, a plate 22 supporting the suction cups 8 to which the mentioned clapet/resilient elements 3 are applied.

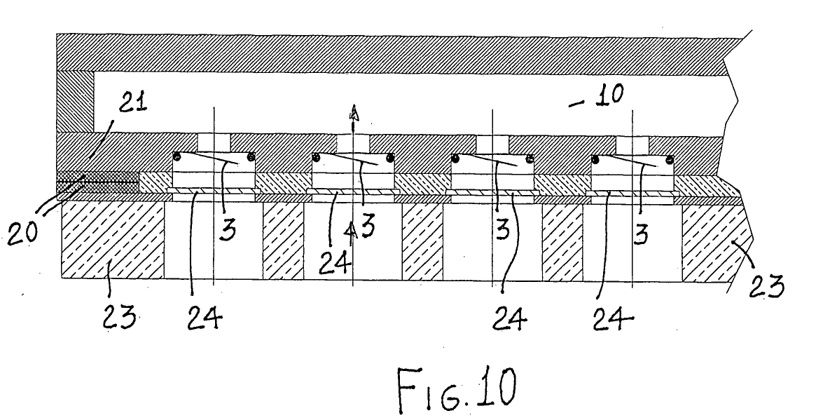

FIG. 10 shows a modified embodiment of the above mentioned negative pressure or vacuum chamber 10, including a bottom surface or panel 21, in which the clapet/resilient elements 3 are engaged, and which is provided with a foamed rubber or the like material elements 23.

FIG. 10 shows moreover filter elements 24 operating to protect the proper operation of the clapet/resilient elements 3.

It has been found that the invention fully achieves the intended aim and objects.

In fact, the invention provides a valve device, adapted to stably and safely grip an article or object, and having a very simple and unexpensive construction, both from a making and an operating standpoint.

In practicing the invention, the used materials, as well as the contingent size and shapes, can be any, depending on the requirements and status of the art.

1. A negative-pressure valve device, for application to general purpose gripping panels, characterized in that said device comprises a flat spring arranged in a two-step cavity and having a shape depending on a size of a seat receiving said flat spring, said flat spring comprising, on a face thereof, an opening and being adapted to bear on said seat to close a passage thereof, as an air flow, generated by a diffusion vacuum pump and passing through said cavity, as acquired a strength sufficient to deform said flat spring.

2. A negative-pressure valve device, according to claim 1, characterized in that the energy provided by said air flow is generated by the kinetic energy of said air flow which, as it impinges on a flat surface, generates a pressure which is transformed into a force.

3. A negative-pressure valve device, according to claim 1, characterized in that, after a closure of said flat spring, which is an untight closure, between said vacuum pump and said flat spring a negative-pressure is generated holding said flat spring in a closure condition.

4. A negative-pressure valve device, according to claim 1, characterized in that said opening of said negative spring holds a small air flow to balance said flat spring as the negative-pressure holding said flat spring in a closure condition stops.

5. A negative-pressure valve device, according to claim 1, characterized in that said flat spring is applied to a suction cup.

6. A negative-pressure valve device, according to claim 5, characterized in that said flat spring is applied to a suction cup on a fitting element or gripping plane having a plurality of passages but a single negative pressure chamber.

7. A negative-pressure valve device, according to claim 1, characterized in that said vacuum pump is adapted to provide, through said negative pressure chamber, an air flow adapted to close said flat spring.

8. A negative-pressure valve device, according to claim 7, characterized in that as said flat spring is closed, a high negative-pressure or vacuum is generated.

9. A negative-pressure valve device, according to claim 6, characterized in that, as an article is arranged under said suction cup, the air flow through said flat spring is shut off, a pressure being balanced and said flat spring is opened thereby providing on said article a maximum negative pressure.

10. A negative-pressure valve device, according to claim 1, characterized in that said opening of said flat spring is designed to provide an air flow-rate as large as possible.

11. A negative-pressure valve device, according to claim 1, characterized in that said device comprises a gripping panel including a plurality of said flat springs wherein, in operation, only the flat springs covered by articles are opened, whereas the flat springs not covered by articles are held in a closed condition, to prevent the negative pressure level from decreasing.

12. A negative-pressure valve device, according to claim 11, characterized in that said articles are gripped in all directions, both upward, downward and horizontally.

13. A negative-pressure valve device, according to claim 1, characterized in that said negative-pressure chamber comprises a bottom to which a Velcro® material or like clamping elements are applied to allow an application of a suction cup supporting plate to which said flat springs are applied.

14. A negative-pressure valve device, according to claim 13, characterized in that said bottom of said negative pressure chamber comprises a plurality of flat springs and a foamed rubber or like material elements.

15. A negative-pressure valve device, according to claim 1, characterized in that said device further comprises filter elements for protecting said flat springs.
